(19) United States
(12) Patent Application Publication
(10) Pub. No.: US 2007/0048589 A1
(43) Pub. Date: Mar. 1, 2007

(54) Integrated micro fuel cell apparatus

(76) Inventors: Chowdary R. Koripella, Scottsdale, AZ (US); John J. D'Urso, Chandler, AZ (US); Steven M. Smith, Gilbert, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/216,316

(22) Filed: Aug. 30, 2005

(51) Int. Cl. H01M 8/24; H01M 8/14; H01M 8/10; H01M 2/08

(52) U.S. Cl. 429/38; 429/46; 429/32; 429/35

(57) ABSTRACT

A micro fuel cell and method of forming such on a substrate (12) is provided that derive power from a three dimensional fuel/oxidant interchange. The fuel cell includes a plurality of porous pedestals (17) formed on the substrate (12), each porous pedestal (17) including an anode (68), a cathode (70) surrounding the anode (68); and an electrolyte (60) filling a cavity between the anode (68) and the cathode (70). The cathode (70) is accessible to ambient air, and the anode (68) has a passageway (30) thereto for receiving a fuel. The anode (68) and cathode (70) may be formed by etching a cavity for the electrolyte (60) or by forming trenches (58, 66) to form each anode (68) and cathode (70), wherein each trench (66) between an anode and cathode is filled with electrolyte.

### FIELD OF THE INVENTION

The present invention generally relates to micro fuel cells, and more particularly to a micro fuel cell apparatus integrated on silicon.

### BACKGROUND OF THE INVENTION

Rechargeable batteries are the primary power source for cell phones and various other portable electronic devices. The energy stored in the batteries is limited. It is determined by the energy density (Wh/L) of the storage material, its chemistry, and the volume of the battery. For example, for a typical Li ion cell phone battery with a 250 Wh/L energy density, a 10 cc battery would store 2.5 Wh of energy. It could last for a few hours to a few days depending on the usage. Recharging always requires an electrical outlet. The limited amount of stored energy and the frequent recharging are major inconveniences with the batteries. There is a need for a longer lasting, easily recharging solution for cell phone power sources. One approach to fulfill this need is to have a hybrid power source with a rechargeable battery and a method to trickle charge the battery. Important considerations for an energy conversion device to recharge the battery include power density, energy density, size and the efficiency of energy conversion.

Energy harvesting methods such as solar cells, thermoelectric generators using ambient temperature fluctuations, and piezoelectric generators using natural vibrations are very attractive power sources to trickle charge a battery. However, the energy generated by these methods is small, usually only a few milliwatt's, and it requires a large volume to generate sufficient power in the hundred of milliwatts needed, making it unattractive for cell phone type applications.

An alternative approach is to carry a high energy density fuel and convert this fuel energy into electrical energy with high efficiency to recharge the battery. Radioactive isotope fuels with high energy density are being investigated for portable power sources. However, the power densities are low with this approach, and also there are safety concerns with the radioactive materials. This is an attractive power source for remote sensor type applications, but not for cell phone power sources. Among the various other energy conversion technologies, the most attractive one is the fuel cell technology because of its high efficiency of energy conversion and the demonstrated feasibility to miniaturize with high efficiency.

Fuel cells with active control systems and high operating temperature fuel cells such as active control direct methanol or formic acid fuel cells (DMFC or DFAFC), reformed hydrogen fuel cells (RHFC) and solid oxide fuel cells (SOFC) are complex systems and very difficult to miniaturize to the 2-5 cc volume needed for cell phone application. Passive air breathing hydrogen fuel cells, passive DMFC or DFAFC, and biofuel cells are attractive systems for this application. However, in addition to the miniaturization issues, other concerns include supply of hydrogen for hydrogen fuel cells, life time and energy density for passive DMFC and DFAFC, and life time, energy density and power density with biofuel cells.

Conventional DMFC and DFAFC designs comprise planar, stacked layers for each cell. Individual cells may then be stacked for higher power, redundancy, and reliability. The layers typically comprise graphite, carbon or carbon composites, polymeric materials, metal such as titanium and stainless steel, and ceramic. The functional area of the stacked layers is restricted, usually on the perimeter, by vias for bolting the structure together and passage of fuel and an oxidant along and between cells. Additionally, the planar, stacked cells derive power only from a fuel/oxidant interchange in a cross sectional area (x and y coordinates).

To design a fuel cell/battery hybrid power source in the same volume as the current cell phone battery (10 cc-2.5 Wh), a smaller battery and a fuel cell with high power density and efficiency would be required to achieve an overall energy density higher than that of the battery alone. For example, for a 4-5 cc (1-1.25 Wh) battery to meet the peak demands of the phone, the fuel cell would need to fit in 1-2 cc, with the fuel taking up the rest of the volume. The power output of the fuel cell needs to be 0.5 W or higher to be able to recharge the battery in a reasonable time. Most development activities on small fuel cells are attempts to miniaturize the traditional fuel cell designs into a small scale, and the resultant systems are still too big for cell phone application. A few micro fuel cell development activities have been disclosed using traditional silicon processing methods in planar fuel cell configurations, and in few cases using porous silicon (to increase the surface area and power densities). See for example, U.S. patent/application Nos. 2004/0185323, 2004/0058226, 6,541,149, and 2003/0003347. However, the power densities of the air breathing planar hydrogen fuel cells are typically in the range of 50-100 mW/cm². To produce 500 mW, it would require 5 cm² or more active area. The operating voltage of a single fuel cell is in the range of 0.5-0.7V. At least four to five cells need to be connected in series to bring the fuel cell operating voltage to 2-3V for efficient DC-DC conversion to 4V in order to charge the Li ion battery. Therefore, the traditional planar fuel cell approach will not be able to meet the requirements in 1-2 cc volume for a fuel cell in the fuel cell/battery hybrid power source for cell phone use.

Accordingly, it is desirable to provide a micro fuel cell apparatus integrated on silicon, glass, ceramic or polymer substrates that derive power from a three dimensional fuel/oxidant interchange. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A micro fuel cell and method of forming such on a substrate is provided that derive power from a three dimensional fuel/oxidant interchange. The fuel cell includes a plurality of porous pedestals formed on a substrate, each porous pedestal including an anode, a cathode surrounding the anode; and an electrolyte filling a cavity between the anode and the cathode. The cathode is accessible to ambient air, and the anode has a passageway thereto for receiving a fuel. The anode and cathode may be formed by etching a cavity for the electrolyte or by forming trenches to form each anode and cathode, wherein each trench between an anode and cathode is filled with electrolyte.

### BRIEF DESCRIPTION OF THE DRAWINGS

The present invention will hereinafter be described in conjunction with the following drawing figures, wherein like numerals denote like elements, and

FIGS. 1-7 are partial cross sectional views showing the layers as fabricated in accordance with an exemplary embodiment of the present invention;

FIG. 8 is a partial cross sectional view of a plurality of fuel cells in accordance with the exemplary embodiment of the present invention;

FIG. 9 is a partial cross sectional top view taken along the line 9-9 of FIG. 8;

FIGS. 10-13 are partial cross sectional views showing the layers as fabricated in accordance with a second exemplary embodiment of the present invention, with FIG. 12 taken along line 12-12 of FIG. 11;

FIG. 14 a partial cross sectional side view of a plurality of fuel cells in accordance with a second exemplary embodiment of the present invention;

FIG. 15 is a partial cross sectional side view of a plurality of fuel cells in accordance with a third exemplary embodiment of the present invention; and

FIG. 16 is a partial cross sectional side view of a plurality of fuel cells in accordance with a fourth exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Fabrication of individual micro fuel cells inside high aspect ratio micro pores provides a high surface area for proton exchange between a fuel (anode) and an oxidant (cathode). At these small dimensions, precise alignment of anode, cathode, electrolyte and current collectors is required to prevent shorting of the cells. This alignment may be accomplished by semiconductor processing methods used in the integrated circuit processing. Functional cells may also be fabricated in ceramic, glass or polymer substrates.

Parallel micro fuel cells in three dimensions fabricated using optical lithography processes typically used in semiconductor integrated circuit processing comprises fuel cells with required power density in a small volume. The cells may be connected in parallel and in series to provide the required output voltage. Functional micro fuel cells are fabricated in micro porous arrays (formed as pedestals) in the substrate. The anode/cathode ion exchange occurs in three dimensions with the anode and cathode areas separated by an insulator. Porous metallic conductors are used at the anode and cathode for gas diffusion and also for current collection. An electrocatalyst is deposited on the walls of the porous metal that are in contact with the electrolyte. A proton conducting electrolyte is contained within the cavities. At such small dimensions, surface tension holds the liquid electrolyte inside the cavities; however, it may be capped on the top. The cavity may optionally be filled with a porous matrix (structure) for holding the electrolyte.

If there is a defect (including a crack or leak) across the electrolyte of a fuel cell, the fuel and oxidant can intermix causing oxidation of the fuel over the catalyst. In a planar stack fuel cell design, this is a serious reliability concern and it is also a yield issue in micro fuel cell fabrication process. In the 3D micro fuel cell design with thousands of micro fuel cells connected in parallel, the current carried by each cell is small. In case of failure in one cell, it will cause only a small incremental increase in current carried by the other cells in the parallel stack without detrimentally affecting their performance. In this design, however, if there is a crack or leak in the electrolyte, then the fuel and oxidant can still intermix causing oxidation of the fuel over the catalyst which is a reliability issue and also affects the fuel utilization. In order to prevent these problems, a self healing mechanism may be incorporated by placing a thermoplastic polymeric material under the electrolyte cap. If there is an intermixing of gases causing micro combustions, then the temperature will rise and the thermoplastic polymer will melt and fill the gaps with an insulator. Though the affected micro fuel cell in the stack will not be functional, it will not cause safety issues or reduce the fuel efficiency through combustion.

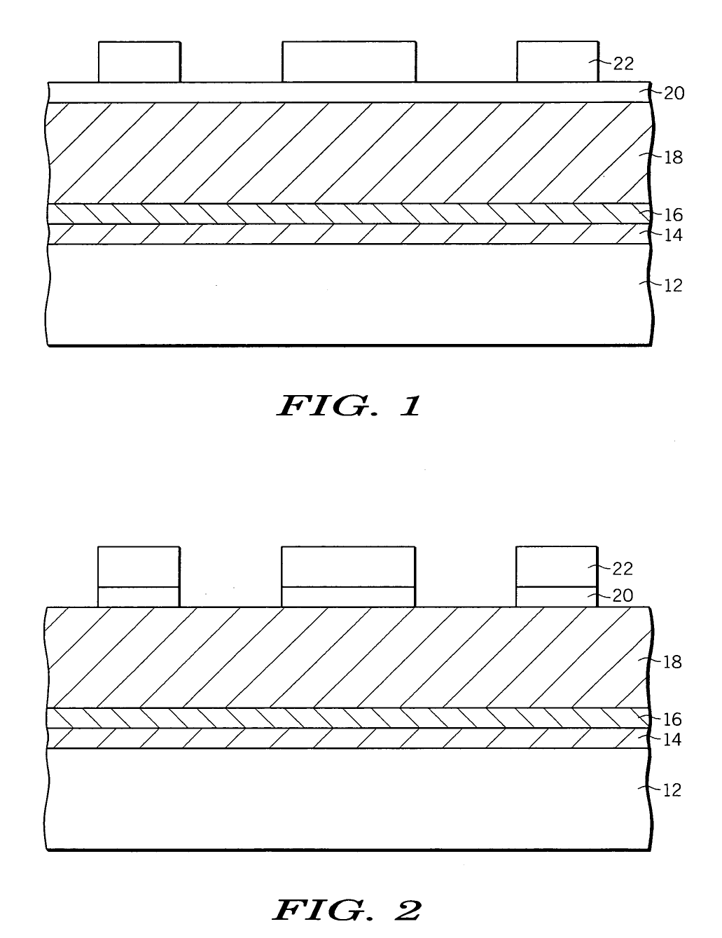

Several possible designs and processing methods are shown schematically in the following figures. FIGS. 1-8 illustrate a process to fabricate fuel cells with a semiconductor process on silicon, glass or a ceramic substrate. Referring to FIG. 1, a thin layer 14 of titanium is deposited on a substrate 12 to provide adhesion for subsequent metallization layers and may also be an electrical back plane (for I/O connections, current traces). The layer 14 may have a thickness in the range of 10-1000A, but preferably is 100A. Metals other than titanium may be used, e.g., tantalum, molybdenum, tungsten, chromium. A gold layer 16 is deposited on the layer 14 for good conduction and also since it is a noble metal more suitable in the oxidizing reducing atmospheres seen during the operation of the fuel cell. The layer 16 may have a thickness in the range of 100A-1 um, but preferably is 1000A. Metals other than gold, e.g., platinum, silver, palladium, ruthenium, nickel, copper, may be used for the layer 16.

A multi-metal layer 18 comprising an alloy of two metals, e.g., silver/gold, copper/silver, nickel/copper, copper/cobalt, nickel/zinc and nickel/iron, and having a thickness in the range of 100-500 um, but preferably 200 um, is deposited on the layer 16. The multi-metal layer 18 is then wet etched to remove one of the metals, leaving behind a porous material. The porous metal layer could also be formed by other methods such as templated self assembled growth or sol-gel methods. A dielectric layer 20 is deposited on the layer 18 and a resist layer 22 is patterned in a manner well known to those in the industry on the dielectric layer 20.

Referring to FIGS. 2-4, using a chemical etch, the dielectric layer 20 not protected by the resist layer 22, is removed. Then, after the resist layer 22 is removed, the multi-metal layer 18, not protected by the dielectric layer 20, is removed to form a porous pedestal 17 comprising a center anode and a concentric cathode surrounding, and separated by a cavity from, the anode. Alternatively, the anode and cathode may be formed simultaneously by templated processes. Concentric as used herein means having a structure having a common center, but the anode, cavity, and cathode walls may take any form and are not to be limited to circles.

The side walls 24 are then coated with an electrocatalyst for anode and cathodic fuel cell reactions by wash coat or some other deposition methods such as CVD, PVD or electrochemical methods (FIG. 5). Then the layers 14 and 16 are etched down to the substrate 12 and an electrolyte material 26 is placed in the cavity (FIG. 6) before a capping layer 28 is formed (FIG. 7) above the electrolyte material 26. Alternatively, the electrolyte material 26 may comprise, for example, perflurosulphonic acid (Nafion®, phosphoric acid, or an ionic liquid electrolyte. Perflurosulphonic acid has a very good ionic conductivity (0.1 S/cm) at room temperature when humidified. The electrolyte material also can be a proton conducting ionic liquids such as a mixture of bistrifluromethane sulfonyl and imidazole, ethylammoniumnitrate, methyammoniumnitrate of dimethylammoniumnitrate, a mixture of ethylammoniumnitrate and imidazole, a mixture of elthylammoniumhydrogensulphate and imidazole, flurosulphonic acid and trifluromethane sulphonic acid. In the case of liquid electrolyte, the cavity needs to be capped to protect the electrolyte from leaking out.

A via, or cavity, 30 is then formed in the substrate 12 by chemical etching (wet or dry) methods. Then, using chemical or physical etching methods, the via 30 is extended through the layer 14 and 16 to the multi-metal layers 18.

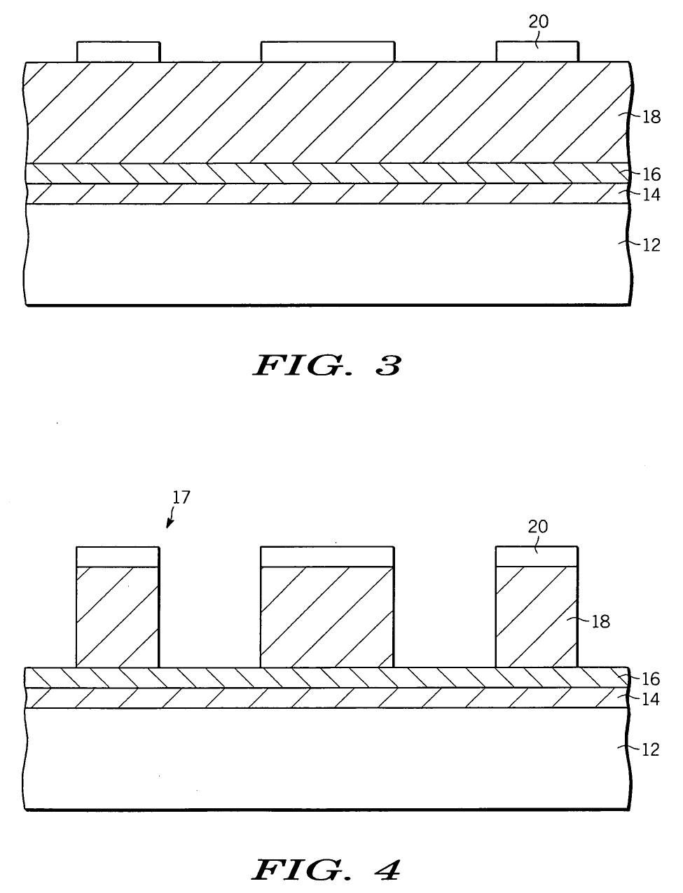

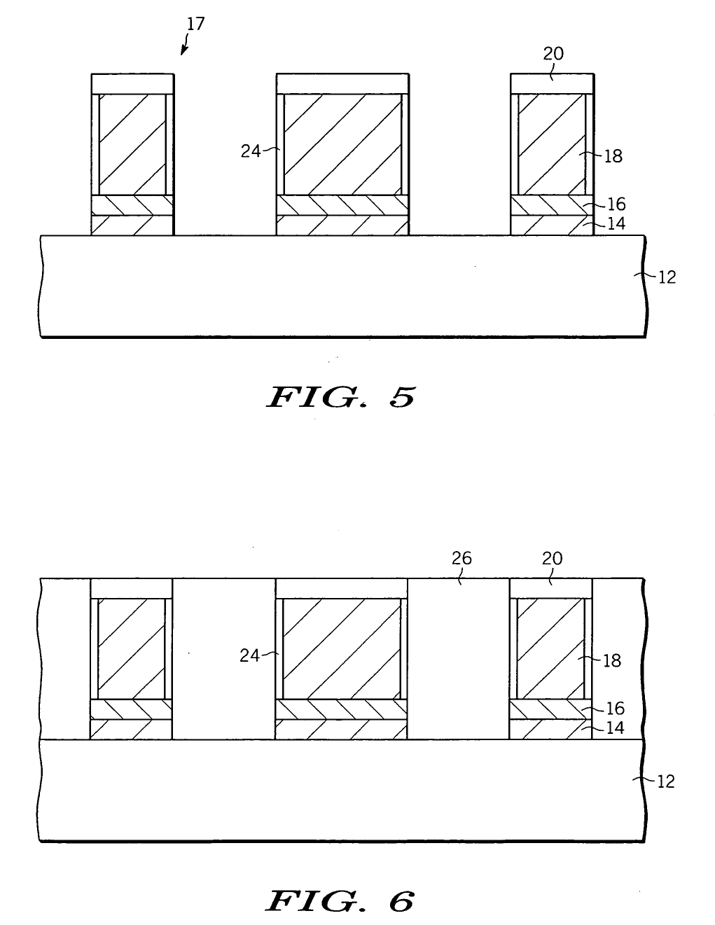

FIGS. 8 and 9 illustrate adjacent fuel cells fabricated in the manner described in reference to FIG. 1-7. The silicon substrate 12, or the substrate containing the micro fuel cells, is positioned on a structure 32 for transporting hydrogen to the cavities 30. The structure 32 may comprise a cavity or series of cavities (e.g., tubes or passageways) formed in a ceramic material, for example. Hydrogen would then enter the hydrogen sections 34 of multi-metal layer 18 above the cavities 30. Since sections 34 are capped with the dielectric layer 20, the hydrogen would stay within the sections 34. Oxidant sections 36 are open to the ambient air, allowing air (including oxygen) to enter oxidant sections 36.

After filling the cavity 18 with the electrolyte material, it will form a physical barrier between the anode (hydrogen feed) and cathode (air breathing) regions. Gas manifolds are built into the bottom packaging substrate to feed hydrogen gas to all the anode regions. Since it is capped on the top 28, it will be like a dead end anode feed configuration fuel cell.

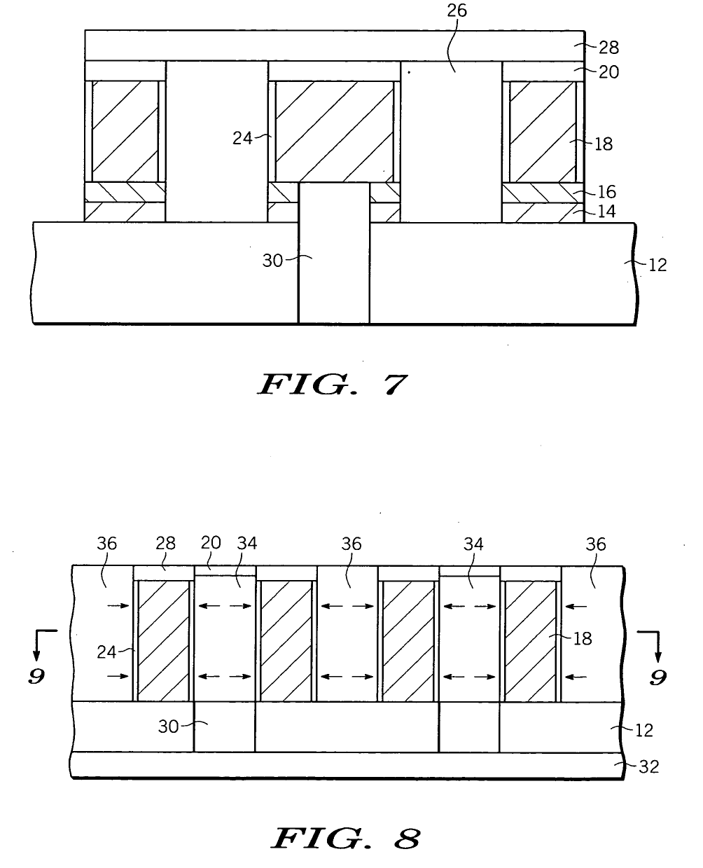

FIGS. 10-13 illustrate another exemplary embodiment of the present invention wherein a metal layer 54 for electrical interconnects is formed on a substrate 52. A thick porous metal 56 is deposited on the metal layer 54, which is patterned and etched to form parallel channels 58. An electrocatalyst 59 is coated on the side walls of the parallel channels 58. The channels 58 are then filled with an electrolyte 60. Alternatively, the channels may first be filled with a porous insulating matrix 62 prior to filling with an electrolyte 60. The channels 58, with the electrolyte 60 therein, are capped with an insulator material 64. A thermoplastic polymeric material 61 may be incorporated under the insulating material 64 for self healing mechanism to prevent intermixing of anode and cathode gases in case of cracks or voids in the electrolyte material by filling in the gaps as described previously. A plurality of channels 66 are etched generally perpendicular to the parallel channels 58, and filled with a dense insulator, e.g., a polymer, dielectric, or ceramic material, which also separate the anode 68 and cathode 70 regions and prevent intermixing of the gases. A metallization layer 72 is deposited on top of the anode section 68 connecting to porous metallization underneath which is the anode of the fuel cell. Interconnects, and conductive traces are made through the insulating layer 66. If necessary a gas impermeable layer may be deposited on top of the anode metal layer to prevent hydrogen gas leakage through the top surface.

The substrate is then back etched forming vias 74 (FIG. 13) to expose the anode porous regions to provide gas (fuel) inlets from the bottom.

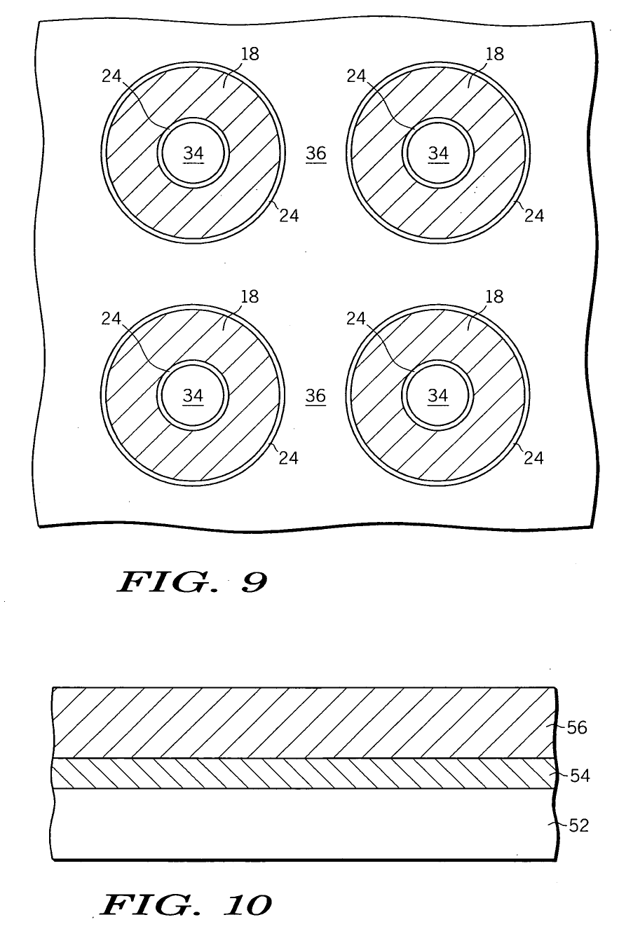

Referring to FIG. 14, a partial cross-sectional view of another exemplary embodiment of the present invention includes carbon nanotubes 38 grown on the porous metal side walls inside the cavity and the electrocatalyst is deposited on the carbon nanotubes. Electrolyte is filled inside the cavity. The presence of the carbon nanotubes 38 provide for improved gas distribution, current collection, and increases the triple point contact (anode or cathode gases, electrolyte and electrode) areas there by improving the overall performance of the fuel cell. The process of growing the carbon nanotubes 38 includes depositing porous metal on silicon, etching the cavities in the porous metal, catalyst metal deposition on the porous metal inside the cavity, followed by growing the carbon nanotubes using CVD process and electrocatalyst deposition. Electrolyte is then filled inside the cavity, and then capped to protect it. Anode and cathode contacts and gas connections are made using the same process as described in the previous section.

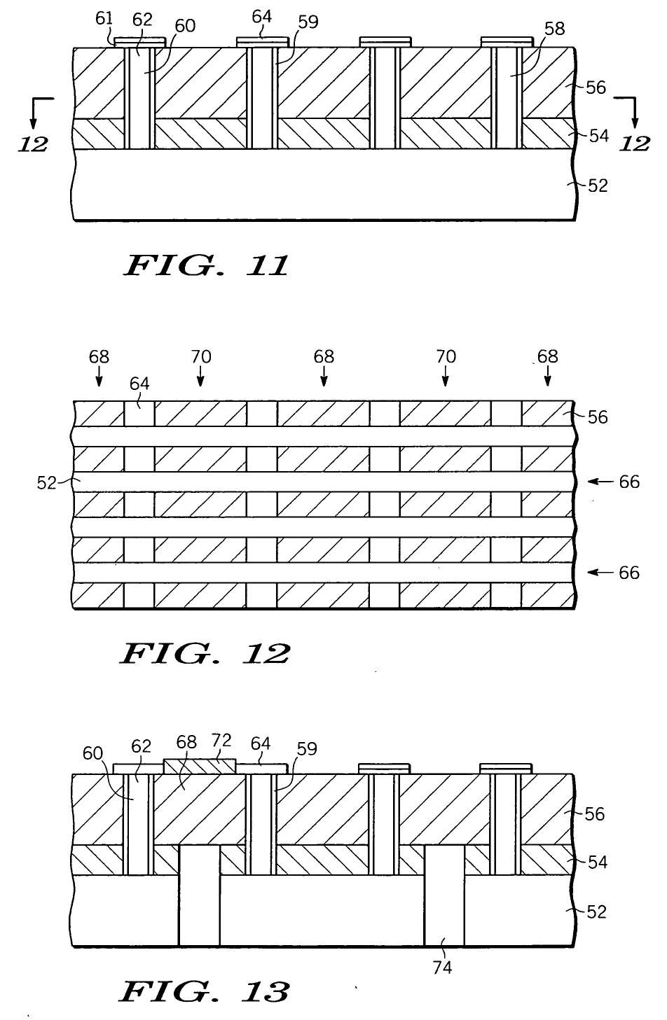

Referring to FIG. 15, a partial cross-sectional view of yet another exemplary embodiment of the present invention includes the cavities 32 in the porous metal layer 18. Cavities 30 on the bottom allow passage of air into the oxidant sections 36. The porous metal layers 18 include hollow carbon nanotubes 42 grown within the cavities formed therearound. The hollow carbon nanotubes 42 and the inside walls of the cavities are catalyzed on the external surface 44 and side walls 40 that is in contact with the electrolyte. Hydrogen flows into the hollow carbon nanotubes 42 from the cavity 32. The carbon nanotubes 42 are blocked at the bottom by the substrate 12 or the catalyst metal print material 46, from which the carbon nanotubes are grown. Fabrication process for this device consists of depositing a bottom metal film on a substrate, which is then patterned to form anode and cathode interconnects and the current collection I/O's. A thick porous metal film is formed on silicon wafer, which is then etched to form cavities in the porous metal for forming the micro fuel cells. At the bottom of the cavity on the substrate surface, a catalyst metal is deposited on top of the anode contact area for the growth of vertical carbon nanotubes inside the cavity. After the carbon nanotube growth, the metal walls inside cavity and the outer surfaces of the carbon nanotubes are coated with an electrocatalyst and the cavity is filled with a proton conducting electrolyte material. In this growth process, care should be taken to avoid electrically contacting the carbon nanotubes with the metal walls to avoid electrically shorting the cells. A thorough coating of carbon nanotubes with the electrolyte material will avoid this problem. After filling the cavities with the electrolyte it will be capped with a dense insulating material and the ends of the carbon nanotubes are planarized to open the tubes for hydrogen flow. A cap is attached to the top of the substrate, which will have an inlet connection to a hydrogen gas supply. In this micro fuel cell design the carbon nanotubes act as an anode as well as the hydrogen gas supply feed tubes. The substrate is then etched through the thickness from the back to form cathode gas supply channels.

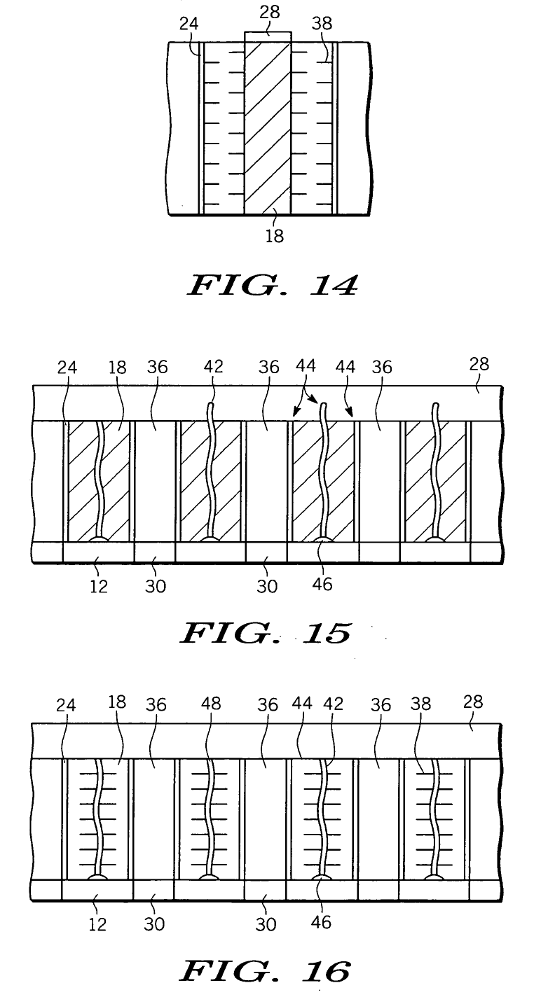

Referring to FIG. 16, yet another exemplary embodiment of the present invention includes a porous metallic nanowire as the anode current collector 48 and for anode gas feeding. The fabrication process would be similar to the process described in the previous section. In addition, carbon nanotubes can be grown inside the cavity from the nanowire along its length and electrocatalyst is deposited on the inside cavity walls (cathode) and the nanowire and carbon nanotubes (anode). The placement of carbon nanotubes help in better diffusion of the anode gases and provide more triple point contact (anode gas, electrolyte and the electrocatalyst or electrode) areas which will help in improved performance of the micro fuel cells.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A fuel cell comprising:
a substrate;
a plurality of porous pedestals formed on the substrate, each pedestal having a first side and a second side;
an electrolyte positioned within each of the plurality of porous pedestals;
a first section adjacent the first side of each pedestal and accessible to ambient air;
a second section adjacent the second side of each pedestal; and
a passageway for supplying a fuel to the second section.

2. The fuel cell of claim 1 wherein the porous pedestals are defined by trenches on four sides of the porous pedestals.

3. The fuel cell of claim 1 wherein the porous pedestals comprise concentric structures including:
an anode;
a cathode surrounding the anode; and
an electrolyte positioned between the anode and the cathode.

4. The fuel cell of claim 1 further comprising a metal interconnects formed between the substrate and the anodes for interconnecting the anodes, and the substrate and the cathodes for interconnecting the cathodes.

5. The fuel cell of claim 1 wherein the electrolyte comprises one of a proton conducting ionic liquid and perflurosulphonic acid.

6. The fuel cell of claim 2 wherein two of the trenches are on opposed sides of the porous pedestals and are filled with a porous insulating matrix.

7. The fuel cell of claim 6 wherein the two trenches on opposed sides include an electrolyte.

8. The fuel cell of claim 6 wherein the two trenches on opposed sides are capped with an insulating material.

9. The fuel cell of claim 6 wherein the other two trenches are filled with an insulator.

10. The fuel cell of claim 8 wherein the insulating material comprises a thermoplastic material.

11. The fuel cell of claim 10 wherein the thermoplastic material may flow to seal defects in the electrolyte.

12. The fuel cell of claim 1 wherein the surface area between the cathode and the electrolyte is larger that the surface area between the anode and the electrolyte.

13. The fuel cell of claim 3 further comprising a first plurality of nanotubes formed from the anode and a second plurality of nanotubes formed from the cathode, the first and second plurality of nanotubes separated from each other by the electrolyte.

14. A method of forming a fuel cell, comprising:
forming a porous layer on a substrate;
forming a plurality of cavities in the porous layer, each of the cavities having a first end adjacent the substrate, a second end, and sidewalls forming a cathode;
growing a plurality of nanotubes in the cavities from the substrate, each nanotube forming an anode;
positioning an electrolyte between each of the plurality of nanotubes and the sidewalls; and
forming a structure for supplying fuel to the nanotubes at the second end.

15. The method of claim 14 further comprising growing a second plurality of nanotubes from each of the first plurality of nanotubes.

16. A method for fabricating a fuel cell, comprising:
depositing a multi-metal layer over a substrate;
etching at least one metal from the multi-metal layer forming a porous metal layer therefrom;
forming a portion of the porous metal resulting in a center anode portion and a concentric cathode portion separated by a concentric cavity;
optionally filling the concentric cavity with a porous insulating matrix;
filling the concentric cavity with an electrolyte; and
capping the center anode portion and the concentric cavity.

17. The method of claim 16 wherein the step of filling the concentric cavity comprises filling the concentric cavity with an electrolyte comprises one of a proton conducting ionic liquid and perflurosulphonic acid.

18. The method of claim 16 further comprising forming a plurality of nanotubes from each of the anode and the cathode and separated by the electrolyte.

19. A method for fabricating a fuel cell, comprising:
forming a porous metal on a substrate;
etching the porous metal to form a first plurality of parallel channels therein, the parallel channels having side walls;
coating the side walls with an electrocatalyst;
optionally filling the channels with a porous insulating matrix;
filling the channels with an electrolyte;
capping the channels with an insulator;
etching the porous metal to form a second plurality of parallel channels at an angle to the first plurality of channels to form a plurality of anodes and a plurality of cathodes;
filling the second plurality of parallel channels with an insulator; and
etching the substrate to provide a plurality of vias for supplying a fuel to the plurality of anodes.

20. The method of claim 16 wherein the step of filling the channels comprises filling the channels with an electrolyte comprises one of a proton conducting ionic liquid and perflurosulphonic acid.
